(19) United States
(12) Patent Application Publication
(10) Pub. No.: US 2019/0166875 A1
(43) Pub. Date: Jun. 6, 2019

(54) COLD DESSERT WITH GELATIN-BASED INCLUSIONS ADAPTED FOR LOW-TEMPERATURE CONSUMPTION

(71) Applicant: Wells Enterprises, Inc., Le Mars, IA (US)

(72) Inventor: David Albrecht, Le Mars, IA (US)

(21) Appl. No.: 16/204,544

(22) Filed: Nov. 29, 2018

Related U.S. Application Data
(60) Provisional application No. 62/593,558, filed on Dec. 1, 2017.

(51) Int. Cl. A23G 9/32; A23G 3/42; A23G 9/40

(52) U.S. Cl. CPC A23G 9/322; A23V 2002/00; A23G 9/40; A23G 3/42

(57) ABSTRACT

A cold dessert includes a cold sweetened food and a gelatin-based candy. The cold sweetened food has a temperature from about −75 to about 3° C. The gelatin-based candy comprises about 36 to about 39 wt. % invert sugar, about 36 to about 39 wt. % sucrose, about 5.5 to about 6.5 wt. % gelatin, and about 17 to about 20 wt. % water.

### CROSS-REFERENCE TO RELATED APPLICATIONS

This application claims the benefit under 35 USC § 119(e) of U.S. Provisional Application Ser. No. 62/593,558, filed on Dec. 1, 2017, the entire disclosure of which is incorporated herein by reference.

### BACKGROUND

Gelatin-based candy products, such as gummy bears, gummy worms, and the like are sometimes added as toppings to ice cream, frozen yogurt, and other cold desserts. Gelatin-based candies have a desirable mouthfeel at room temperature, which includes a soft and pliable texture and a continuous, controlled release of flavor. However, these candies harden at colder temperatures, such as the temperatures associated with ice cream, frozen yogurt, and the like and can also stick to consumers' teeth. Also, these cold temperatures interfere with the candies' rates of flavor release. As such, there is a need for new gelatin-based candies that retain desirable mouthfeel without excessive stickiness at cold temperatures.

### SUMMARY

A cold dessert according to the present disclosure may include a cold sweetened food and a gelatin-based candy suspended in the cold sweetened food. The cold sweetened food may be ice cream, frozen yogurt, or the like having a temperature from about −75 to about 3° C. The gelatin-based candy may be formulated with invert sugar to provide a soft texture at the temperature of the cold sweetened food.

In illustrative embodiments, the gelatin-based candy may comprise about 15 to about 70 wt. % invert sugar. The gelatin-based candy may also comprise about 4 to about 8 wt. % gelatin. The gelatin may have a bloom number of about 150 to about 225. The gelatin-based candy may also comprise about 5 to about 20 wt. % water.

According to another aspect of the present disclosure, a gelatin-based candy suitable for consumption at cold temperatures with or without other food is described. The gelatin-based candy may comprise about 15 to about 70 wt. % invert sugar. The gelatin-based candy may also comprise about 4 to about 8 wt. % gelatin. The gelatin may have a bloom number of about 150 to about 225. The gelatin-based candy may also comprise about 5 to about 20 wt. % water.

In illustrative embodiments, vitamins and/or minerals may be added to the gelatin-based candy. The addition of vitamins and/or minerals may be desired to promote health benefits of a food product incorporating the gelatin-based candy.

Additional features of the present disclosure will become apparent to those skilled in the art upon consideration of illustrative embodiments exemplifying the best mode of carrying out the disclosure as presently perceived.

### DETAILED DESCRIPTION

For the purposes of promoting an understanding of the principles of the disclosure, reference will now be made to a number of illustrative embodiments and specific language will be used to describe the same.

According to the present disclosure, gelatin-based candy products and formulations for making the same are described. The candy products comprise, among other things, a quantity of invert sugar that imparts improved softness and pliability at cold temperatures compared to conventional gelatin-based candies. Consumers can comfortably chew the candy products at cold temperatures without the products excessively sticking to the consumers' teeth. Also, the candy products described herein release flavor at a more desirable rate at cold temperatures compared to conventional gelatin-based candies.

In illustrative embodiments, vitamins and/or minerals may be added to the gelatin-based candy. The addition of vitamins and/or minerals may be desired to promote health benefits of a food product incorporating the gelatin-based candy.

As used herein, “cold” refers to temperatures between about −75° C. and about 10° C. In some embodiments, the candy products of the present disclosure exhibit improved softness compared to conventional gelatin-based candies at temperatures between about −75° C. and about 0° C., about −75° C. and about 3° C., −40° C. and about 5° C., about −30° C. and about 5° C., about −25° C. and about 3° C., and/or about −20° C. and about 0° C.

In some embodiments, the candy products of the present disclosure are cold due to the presence of a cold sweetened food. For example, the candy products may be mixed into, placed on the surface of, or otherwise put in thermal communication with a cold sweetened food, such as ice cream. It is contemplated that the candy products may be added to the cold sweetened food and the combination may be packaged before being distributed to a consumer. The cold sweetened food may be stored at a temperature between about −75° C. and about 0° C., about −75° C. and about 3° C., −75° C. and about 10° C., about −40° C. and about 5° C., about −30° C. and about 5° C., about −25° C. and about 3° C., and/or about −20° C. and about 0° C.

Cold sweetened foods useful with the candy products include but are not limited to cold dairy-based desserts, cold diary-substitute-based desserts, ice cream, soft-serve ice cream, gelato, frozen custard, soy milk ice cream, nut milk ice cream, coconut milk ice cream, avocado-based ice cream, frozen yogurt, frozen Greek yogurt, frozen kefir, a parfait, sorbet, sherbet, a frozen novelty, a fruit frozen novelty, a fudge frozen novelty, a frozen stick confection, a fruit frozen stick confection, a fudge frozen stick confection, a water ice confection, a fruit water ice confection, a fudge water ice confection, cheesecake, cake, pie, a milkshake, a malt, a smoothie, frozen fruit, Italian ice, a snow cone, whipped cream, and combinations of the foregoing.

In some embodiments, the gelatin-based candy products are molded into various shapes including but not limited to bears, bunnies, sharks, fish, worms, bottles, cherries, oranges, watermelon slices, rings, sushi, and gumdrop shapes.

In a preferred embodiment, gummy bears or bunnies are mixed into ice cream. The mixture is packaged for distribution to a consumer.

The candy products are formed by methods for forming gelatin-based candies. In some embodiments, the gelatin-based candy products are formed from an initial mixture comprising a gelling component, invert sugar, and water. In some embodiments, the mixture further comprises one or more additional sweeteners including sugars and sugar substitutes. Also, the mixture preferably comprises one or more natural or artificial flavor agents.

In some embodiments, the initial mixture comprising the gelling component, invert sugar, and any additional components such as additional sweeteners and flavor agents are dissolved in water at an elevated temperature. The mixture is cooled and allowed to gel, forming the gelatin-based candy product. As a result of the formation process, the gelatin-based candy product has a decreased water content compared to the initial mixture.

It is contemplated that various gelling components that may be used for forming gummy candy products in accordance with the present disclosure. Suitable gelling components include but are not limited to gelatin, collagen, pectin, carnauba wax, carrageenan, agar, vegetable gums, guar gum, xantham gum, gum arabic, locust bean gum, tapioca starch, and combinations of the foregoing. In view of this, non-gelatin-based candies are envisioned in which non-gelatin based gummy candies may be manufactured with other gelling components while still taking advantage of the teaching of the present disclosure.

In some embodiments the gelling component is bovine gelatin, porcine gelatin, or piscine gelatin. The gelatin may have a bloom value of greater than about 125, greater than about 150, greater than about 175, about 125 to about 350, about 150 to about 350, about 175 to about 350, about 125 to about 250, about 150 to about 250, about 175 to about 250, about 125 to about 225, about 150 to about 225, about 175 to about 225, about 125 to about 200, about 150 to about 200, about 175 to about 200, or about 175.

In some embodiments, prior to heating and gelling, the gelling component, by dry weight, comprises about 1 wt. % to about 10 wt. %, about 2 wt. % to about 9 wt. %, about 2 wt. % to about 8 wt. %, about 3 wt. % to about 8 wt. %, about 4 wt. % to about 8 wt. %, about 5 wt. % to about 8 wt. %, about 2 wt. % to about 7 wt. %, about 3 wt. % to about 7 wt. %, about 4 wt. % to about 7 wt. %, about 5 wt. % to about 7 wt. %, about 2 wt. % to about 6 wt. %, about 3 wt. % to about 6 wt. %, about 6 wt. % to about 6 wt. %, about 5 wt. % to about 6 wt. %, or about 5.7 wt. % of the initial mixture. After heating and gelling, the gelling component, by dry weight, comprises about 1.5 wt. % to about 10.5 wt. %, about 2.5 wt. % to about 9.5 wt. %, about 2.5 wt. % to about 8.5 wt. %, about 3.5 wt. % to about 8.5 wt. %, about 4.5 wt. % to about 8.5 wt. %, about 5.5 wt. % to about 8.5 wt. %, about 2.5 wt. % to about 7.5 wt. %, about 3.5 wt. % to about 7.5 wt. %, about 4.5 wt. % to about 7.5 wt. %, about 5.5 wt. % to about 7.5 wt. %, about 2.5 wt. % to about 6.5 wt. %, about 3.5 wt. % to about 6.5 wt. %, about 6.5 wt. % to about 6.5 wt. %, about 5.5 wt. % to about 6.5 wt. %, or about 6.14 wt. % of the gelatin-based candy product.

In other embodiments, prior to heating and gelling, the gelling component, by dry weight, consists essentially of about 1 wt. % to about 10 wt. %, about 2 wt. % to about 9 wt. %, about 2 wt. % to about 8 wt. %, about 3 wt. % to about 8 wt. %, about 4 wt. % to about 8 wt. %, about 5 wt. % to about 8 wt. %, about 2 wt. % to about 7 wt. %, about 3 wt. % to about 7 wt. %, about 4 wt. % to about 7 wt. %, about 5 wt. % to about 7 wt. %, about 2 wt. % to about 6 wt. %, about 3 wt. % to about 6 wt. %, about 6 wt. % to about 6 wt. %, about 5 wt. % to about 6 wt. %, or about 5.7 wt. % of the initial mixture. After heating and gelling, the gelling component, by dry weight, can consist essentially of about 1.5 wt. % to about 10.5 wt. %, about 2.5 wt. % to about 9.5 wt. %, about 2.5 wt. % to about 8.5 wt. %, about 3.5 wt. % to about 8.5 wt. %, about 4.5 wt. % to about 8.5 wt. %, about 5.5 wt. % to about 8.5 wt. %, about 2.5 wt. % to about 7.5 wt. %, about 3.5 wt. % to about 7.5 wt. %, about 4.5 wt. % to about 7.5 wt. %, about 5.5 wt. % to about 7.5 wt. %, about 2.5 wt. % to about 6.5 wt. %, about 3.5 wt. % to about 6.5 wt. %, about 6.5 wt. % to about 6.5 wt. %, about 5.5 wt. % to about 6.5 wt. %, or about 6.14 wt. % of the gelatin-based candy product.

In yet other embodiments, prior to heating and gelling, the gelling component, by dry weight, consists of about 1 wt. % to about 10 wt. %, about 2 wt. % to about 9 wt. %, about 2 wt. % to about 8 wt. %, about 3 wt. % to about 8 wt. %, about 4 wt. % to about 8 wt. %, about 5 wt. % to about 8 wt. %, about 2 wt. % to about 7 wt. %, about 3 wt. % to about 7 wt. %, about 4 wt. % to about 7 wt. %, about 5 wt. % to about 7 wt. %, about 2 wt. % to about 6 wt. %, about 3 wt. % to about 6 wt. %, about 6 wt. % to about 6 wt. %, about 5 wt. % to about 6 wt. %, or about 5.7 wt. % of the initial mixture. After heating and gelling, the gelling component, by dry weight, can consist of about 1.5 wt. % to about 10.5 wt. %, about 2.5 wt. % to about 9.5 wt. %, about 2.5 wt. % to about 8.5 wt. %, about 3.5 wt. % to about 8.5 wt. %, about 4.5 wt. % to about 8.5 wt. %, about 5.5 wt. % to about 8.5 wt. %, about 2.5 wt. % to about 7.5 wt. %, about 3.5 wt. % to about 7.5 wt. %, about 4.5 wt. % to about 7.5 wt. %, about 5.5 wt. % to about 7.5 wt. %, about 2.5 wt. % to about 6.5 wt. %, about 3.5 wt. % to about 6.5 wt. %, about 6.5 wt. % to about 6.5 wt. %, about 5.5 wt. % to about 6.5 wt. %, or about 6.14 wt. % of the gelatin-based candy product.

In some embodiments, the invert sugar, by dry weight, comprises about 10 wt. % to about 85 wt. %, about 10 wt. % to about 70 wt. %, about 10 wt. % to about 55 wt. %, about 10 wt. % to about 45 wt. %, about 10 wt. % to about 40 wt. %, about 15 wt. % to about 85 wt. %, about 15 wt. % to about 70 wt. %, about 15 wt. % to about 55 wt. %, about 15 wt. % to about 45 wt. %, about 15 wt. % to about 40 wt. %, about 20 wt. % to about 85 wt. %, about 20 wt. % to about 70 wt. %, about 20 wt. % to about 55 wt. %, about 20 wt. % to about 45 wt. %, about 20 wt. % to about 40 wt. %, about 25 wt. % to about 85 wt. %, about 25 wt. % to about 70 wt. %, about 25 wt. % to about 55 wt. %, about 25 wt. % to about 45 wt. %, about 25 wt. % to about 40 wt. %, about 30 wt. % to about 85 wt. %, about 30 wt. % to about 70 wt. %, about 30 wt. % to about 55 wt. %, about 30 wt. % to about 45 wt. %, about 30 wt. % to about 40 wt. %, or about 35 wt. % of the initial mixture. After heating and gelling, the invert sugar, by dry weight, comprises about 15 wt. % to about 90 wt. %, about 15 wt. % to about 75 wt. %, about 15 wt. % to about 60 wt. %, about 15 wt. % to about 50 wt. %, about 15 wt. % to about 45 wt. %, about 20 wt. % to about 90 wt. %, about 20 wt. % to about 75 wt. %, about 25 wt. % to about 60 wt. %, about 20 wt. % to about 50 wt. %, about 20 wt. % to about 45 wt. %, about 25 wt. % to about 90 wt. %, about 25 wt. % to about 75 wt. %, about 25 wt. % to about 60 wt. %, about 25 wt. % to about 50 wt. %, about 25 wt. % to about 45 wt. %, about 30 wt. % to about 90 wt. %, about 30 wt. % to about 75 wt. %, about 30 wt. % to about 60 wt. %, about 30 wt. % to about 50 wt. %, about 30 wt. % to about 45 wt. %, about 35 wt. % to about 90 wt. %, about 35 wt. % to about 75 wt. %, about 35 wt. % to about 60 wt. %, about 35 wt. % to about 50 wt. %, about 35 wt. % to about 45 wt. %, or about 37.5 wt. % of the gelatin-based candy product.

In other embodiments, the invert sugar, by dry weight, consists essentially of about 10 wt. % to about 85 wt. %, about 10 wt. % to about 70 wt. %, about 10 wt. % to about 55 wt. %, about 10 wt. % to about 45 wt. %, about 10 wt. % to about 40 wt. %, about 15 wt. % to about 85 wt. %, about 15 wt. % to about 70 wt. %, about 15 wt. % to about 55 wt. %, about 15 wt. % to about 45 wt. %, about 15 wt. % to about 40 wt. %, about 20 wt. % to about 85 wt. %, about 20 wt. % to about 70 wt. %, about 20 wt. % to about 55 wt. %, about 20 wt. % to about 45 wt. %, about 20 wt. % to about 40 wt. %, about 25 wt. % to about 85 wt. %, about 25 wt. % to about 70 wt. %, about 25 wt. % to about 55 wt. %, about 25 wt. % to about 45 wt. %, about 25 wt. % to about 40 wt. %, about 30 wt. % to about 85 wt. %, about 30 wt. % to about 70 wt. %, about 30 wt. % to about 55 wt. %, about 30 wt. % to about 45 wt. %, about 30 wt. % to about 40 wt. %, or about 35 wt. % of the initial mixture. After heating and gelling, the invert sugar, by dry weight, can consist essentially of about 15 wt. % to about 90 wt. %, about 15 wt. % to about 75 wt. %, about 15 wt. % to about 60 wt. %, about 15 wt. % to about 50 wt. %, about 15 wt. % to about 45 wt. %, about 20 wt. % to about 90 wt. %, about 20 wt. % to about 75 wt. %, about 25 wt. % to about 60 wt. %, about 20 wt. % to about 50 wt. %, about 20 wt. % to about 45 wt. %, about 25 wt. % to about 90 wt. %, about 25 wt. % to about 75 wt. %, about 25 wt. % to about 60 wt. %, about 25 wt. % to about 50 wt. %, about 25 wt. % to about 45 wt. %, about 30 wt. % to about 90 wt. %, about 30 wt. % to about 75 wt. %, about 30 wt. % to about 60 wt. %, about 30 wt. % to about 50 wt. %, about 30 wt. % to about 45 wt. %, about 35 wt. % to about 90 wt. %, about 35 wt. % to about 75 wt. %, about 35 wt. % to about 60 wt. %, about 35 wt. % to about 50 wt. %, about 35 wt. % to about 45 wt. %, or about 37.5 wt. % of the gelatin-based candy product.

In yet other embodiments, the invert sugar, by dry weight, consists of about 10 wt. % to about 85 wt. %, about 10 wt. % to about 70 wt. %, about 10 wt. % to about 55 wt. %, about 10 wt. % to about 45 wt. %, about 10 wt. % to about 40 wt. %, about 15 wt. % to about 85 wt. %, about 15 wt. % to about 70 wt. %, about 15 wt. % to about 55 wt. %, about 15 wt. % to about 45 wt. %, about 15 wt. % to about 40 wt. %, about 20 wt. % to about 85 wt. %, about 20 wt. % to about 70 wt. %, about 20 wt. % to about 55 wt. %, about 20 wt. % to about 45 wt. %, about 20 wt. % to about 40 wt. %, about 25 wt. % to about 85 wt. %, about 25 wt. % to about 70 wt. %, about 25 wt. % to about 55 wt. %, about 25 wt. % to about 45 wt. %, about 25 wt. % to about 40 wt. %, about 30 wt. % to about 85 wt. %, about 30 wt. % to about 70 wt. %, about 30 wt. % to about 55 wt. %, about 30 wt. % to about 45 wt. %, about 30 wt. % to about 40 wt. %, or about 35 wt. % of the initial mixture. After heating and gelling, the invert sugar, by dry weight, can consist of about 15 wt. % to about 90 wt. %, about 15 wt. % to about 75 wt. %, about 15 wt. % to about 60 wt. %, about 15 wt. % to about 50 wt. %, about 15 wt. % to about 45 wt. %, about 20 wt. % to about 90 wt. %, about 20 wt. % to about 75 wt. %, about 25 wt. % to about 60 wt. %, about 20 wt. % to about 50 wt. %, about 20 wt. % to about 45 wt. %, about 25 wt. % to about 90 wt. %, about 25 wt. % to about 75 wt. %, about 25 wt. % to about 60 wt. %, about 25 wt. % to about 50 wt. %, about 25 wt. % to about 45 wt. %, about 30 wt. % to about 90 wt. %, about 30 wt. % to about 75 wt. %, about 30 wt. % to about 60 wt. %, about 30 wt. % to about 50 wt. %, about 30 wt. % to about 45 wt. %, about 35 wt. % to about 90 wt. %, about 35 wt. % to about 75 wt. %, about 35 wt. % to about 60 wt. %, about 35 wt. % to about 50 wt. %, about 35 wt. % to about 45 wt. %, or about 37.5 wt. % of the gelatin-based candy product.

The candy products may further comprise one or more additional sugars including but not limited to sucrose, fructose, glucose, honey, high fructose corn syrup, maple syrup, molasses, and combinations of the foregoing. The one or more additional sugars may be added to the initial formulation as a dry sugar, as a syrup, or as an aqueous solution.

In some embodiments, the one or more additional sugars, by dry weight, comprise about 0 wt. % to about 85 wt. %, about 0 wt. % to about 70 wt. %, about 0 wt. % to about 55 wt. %, about 0 wt. % to about 45 wt. %, about 0 wt. % to about 40 wt. %, about 10 wt. % to about 85 wt. %, about 10 wt. % to about 70 wt. %, about 10 wt. % to about 55 wt. %, about 10 wt. % to about 45 wt. %, about 10 wt. % to about 40 wt. %, about 15 wt. % to about 85 wt. %, about 15 wt. % to about 70 wt. %, about 15 wt. % to about 55 wt. %, about 15 wt. % to about 45 wt. %, about 15 wt. % to about 40 wt. %, about 20 wt. % to about 85 wt. %, about 20 wt. % to about 70 wt. %, about 20 wt. % to about 55 wt. %, about 20 wt. % to about 45 wt. %, about 20 wt. % to about 40 wt. %, about 25 wt. % to about 85 wt. %, about 25 wt. % to about 70 wt. %, about 25 wt. % to about 55 wt. %, about 25 wt. % to about 45 wt. %, about 25 wt. % to about 40 wt. %, about 30 wt. % to about 85 wt. %, about 30 wt. % to about 70 wt. %, about 30 wt. % to about 55 wt. %, about 30 wt. % to about 45 wt. %, about 30 wt. % to about 40 wt. %, or about 35 wt. % of the initial mixture. After heating and gelling, the one or more additional sugars, by dry weight, comprise about 0 wt. % to about 90 wt. %, about 0 wt. % to about 75 wt. %, about 0 wt. % to about 60 wt. %, about 0 wt. % to about 50 wt. %, about 0 wt. % to about 45 wt. %, about 15 wt. % to about 90 wt. %, about 15 wt. % to about 75 wt. %, about 15 wt. % to about 60 wt. %, about 15 wt. % to about 50 wt. %, about 15 wt. % to about 45 wt. %, about 20 wt. % to about 90 wt. %, about 20 wt. % to about 75 wt. %, about 25 wt. % to about 60 wt. %, about 20 wt. % to about 50 wt. %, about 20 wt. % to about 45 wt. %, about 25 wt. % to about 90 wt. %, about 25 wt. % to about 75 wt. %, about 25 wt. % to about 60 wt. %, about 25 wt. % to about 50 wt. %, about 25 wt. % to about 45 wt. %, about 30 wt. % to about 90 wt. %, about 30 wt. % to about 75 wt. %, about 30 wt. % to about 60 wt. %, about 30 wt. % to about 50 wt. %, about 30 wt. % to about 45 wt. %, about 35 wt. % to about 90 wt. %, about 35 wt. % to about 75 wt. %, about 35 wt. % to about 60 wt. %, about 35 wt. % to about 50 wt. %, about 35 wt. % to about 45 wt. %, or about 37.5 wt. % of the gelatin-based candy product.

In other embodiments, the one or more additional sugars, by dry weight, consists essentially of about 0 wt. % to about 85 wt. %, about 0 wt. % to about 70 wt. %, about 0 wt. % to about 55 wt. %, about 0 wt. % to about 45 wt. %, about 0 wt. % to about 40 wt. %, about 10 wt. % to about 85 wt. %, about 10 wt. % to about 70 wt. %, about 10 wt. % to about 55 wt. %, about 10 wt. % to about 45 wt. %, about 10 wt. % to about 40 wt. %, about 15 wt. % to about 85 wt. %, about 15 wt. % to about 70 wt. %, about 15 wt. % to about 55 wt. %, about 15 wt. % to about 45 wt. %, about 15 wt. % to about 40 wt. %, about 20 wt. % to about 85 wt. %, about 20 wt. % to about 70 wt. %, about 20 wt. % to about 55 wt. %, about 20 wt. % to about 45 wt. %, about 20 wt. % to about 40 wt. %, about 25 wt. % to about 85 wt. %, about 25 wt. % to about 70 wt. %, about 25 wt. % to about 55 wt. %, about 25 wt. % to about 45 wt. %, about 25 wt. % to about 40 wt. %, about 30 wt. % to about 85 wt. %, about 30 wt. % to about 70 wt. %, about 30 wt. % to about 55 wt. %, about 30 wt. % to about 45 wt. %, about 30 wt. % to about 40 wt. %, or about 35 wt. % of the initial mixture. After heating and gelling, the one or more additional sugars, by dry weight, can consist essentially of about 0 wt. % to about 90 wt. %, about 0 wt. % to about 75 wt. %, about 0 wt. % to about 60 wt. %, about 0 wt. % to about 50 wt. %, about 0 wt. % to about 45 wt. %, about 15 wt. % to about 90 wt. %, about 15 wt. % to about 75 wt. %, about 15 wt. % to about 60 wt. %, about 15 wt. % to about 50 wt. %, about 15 wt. % to about 45 wt. %, about 20 wt. % to about 90 wt. %, about 20 wt. % to about 75 wt. %, about 25 wt. % to about 60 wt. %, about 20 wt. % to about 50 wt. %, about 20 wt. % to about 45 wt. %, about 25 wt. % to about 90 wt. %, about 25 wt. % to about 75 wt. %, about 25 wt. % to about 60 wt. %, about 25 wt. % to about 50 wt. %, about 25 wt. % to about 45 wt. %, about 30 wt. % to about 90 wt. %, about 30 wt. % to about 75 wt. %, about 30 wt. % to about 60 wt. %, about 30 wt. % to about 50 wt. %, about 30 wt. % to about 45 wt. %, about 35 wt. % to about 90 wt. %, about 35 wt. % to about 75 wt. %, about 35 wt. % to about 60 wt. %, about 35 wt. % to about 50 wt. %, about 35 wt. % to about 45 wt. %, or about 37.5 wt. % of the gelatin-based candy product.

In yet other embodiments, the one or more additional sugars, by dry weight, consists of about 0 wt. % to about 85 wt. %, about 0 wt. % to about 70 wt. %, about 0 wt. % to about 55 wt. %, about 0 wt. % to about 45 wt. %, about 0 wt. % to about 40 wt. %, about 10 wt. % to about 85 wt. %, about 10 wt. % to about 70 wt. %, about 10 wt. % to about 55 wt. %, about 10 wt. % to about 45 wt. %, about 10 wt. % to about 40 wt. %, about 15 wt. % to about 85 wt. %, about 15 wt. % to about 70 wt. %, about 15 wt. % to about 55 wt. %, about 15 wt. % to about 45 wt. %, about 15 wt. % to about 40 wt. %, about 20 wt. % to about 85 wt. %, about 20 wt. % to about 70 wt. %, about 20 wt. % to about 55 wt. %, about 20 wt. % to about 45 wt. %, about 20 wt. % to about 40 wt. %, about 25 wt. % to about 85 wt. %, about 25 wt. % to about 70 wt. %, about 25 wt. % to about 55 wt. %, about 25 wt. % to about 45 wt. %, about 25 wt. % to about 40 wt. %, about 30 wt. % to about 85 wt. %, about 30 wt. % to about 70 wt. %, about 30 wt. % to about 55 wt. %, about 30 wt. % to about 45 wt. %, about 30 wt. % to about 40 wt. %, or about 35 wt. % of the initial mixture. After heating and gelling, the one or more additional sugars, by dry weight, can consist of about 0 wt. % to about 90 wt. %, about 0 wt. % to about 75 wt. %, about 0 wt. % to about 60 wt. %, about 0 wt. % to about 50 wt. %, about 0 wt. % to about 45 wt. %, about 15 wt. % to about 90 wt. %, about 15 wt. % to about 75 wt. %, about 15 wt. % to about 60 wt. %, about 15 wt. % to about 50 wt. %, about 15 wt. % to about 45 wt. %, about 20 wt. % to about 90 wt. %, about 20 wt. % to about 75 wt. %, about 25 wt. % to about 60 wt. %, about 20 wt. % to about 50 wt. %, about 20 wt. % to about 45 wt. %, about 25 wt. % to about 90 wt. %, about 25 wt. % to about 75 wt. %, about 25 wt. % to about 60 wt. %, about 25 wt. % to about 50 wt. %, about 25 wt. % to about 45 wt. %, about 30 wt. % to about 90 wt. %, about 30 wt. % to about 75 wt. %, about 30 wt. % to about 60 wt. %, about 30 wt. % to about 50 wt. %, about 30 wt. % to about 45 wt. %, about 35 wt. % to about 90 wt. %, about 35 wt. % to about 75 wt. %, about 35 wt. % to about 60 wt. %, about 35 wt. % to about 50 wt. %, about 35 wt. % to about 45 wt. %, or about 37.5 wt. % of the gelatin-based candy product.

In some embodiments, water comprises about 5 wt. % to about 30 wt. %, about 10 wt. % to about 30 wt. %, about 15 wt. % to about 30 wt. %, about 20 wt. % to about 30 wt. %, about 5 wt. % to about 25 wt. %, about 10 wt. % to about 25 wt. %, about 15 wt. % to about 25 wt. %, about 20 wt. % to about 25 wt. %, or about 25 wt. % of the initial mixture. Water comprises about 5 wt. % to about 25 wt. %, about 10 wt. % to about 25 wt. %, about 15 wt. % to about 25 wt. %, about 5 wt. % to about 20 wt. %, about 10 wt. % to about 20 wt. %, about 15 wt. % to about 20 wt. %, or about 19 wt. % of the gelatin-based candy product.

In other embodiments, water consists essentially of about 5 wt. % to about 30 wt. %, about 10 wt. % to about 30 wt. %, about 15 wt. % to about 30 wt. %, about 20 wt. % to about 30 wt. %, about 5 wt. % to about 25 wt. %, about 10 wt. % to about 25 wt. %, about 15 wt. % to about 25 wt. %, about 20 wt. % to about 25 wt. %, or about 25 wt. % of the initial mixture. Water can consist essentially of about 5 wt. % to about 25 wt. %, about 10 wt. % to about 25 wt. %, about 15 wt. % to about 25 wt. %, about 5 wt. % to about 20 wt. %, about 10 wt. % to about 20 wt. %, about 15 wt. % to about 20 wt. %, or about 19 wt. % of the gelatin-based candy product.

In yet other embodiments, water consists of about 5 wt. % to about 30 wt. %, about 10 wt. % to about 30 wt. %, about 15 wt. % to about 30 wt. %, about 20 wt. % to about 30 wt. %, about 5 wt. % to about 25 wt. %, about 10 wt. % to about 25 wt. %, about 15 wt. % to about 25 wt. %, about 20 wt. % to about 25 wt. %, or about 25 wt. % of the initial mixture. Water can consist of about 5 wt. % to about 25 wt. %, about 10 wt. % to about 25 wt. %, about 15 wt. % to about 25 wt. %, about 5 wt. % to about 20 wt. %, about 10 wt. % to about 20 wt. %, about 15 wt. % to about 20 wt. %, or about 19 wt. % of the gelatin-based candy product.

The candy products may further comprise one or more sugars substitutes including but not limited to saccharin, aspartame, acesulfame potassium, sucralose, stevia, sorbitol, xylitol, mannitol, maltitol, erythritol, isomalt, lactitol, glycerol, and combinations of the foregoing.

In some embodiments, the candy products comprise less than about 1 wt. % high fructose corn syrup. In some embodiments, the candy products comprise less than about 1 wt. % cornstarch. In some embodiments, the candy products comprise gelatin and comprise less than about 1 wt. % or less than about 0.1 wt. % of any other gelling component.

The candy products preferably further comprise one or more natural and/or artificial flavor agents including but not limited to strawberry, cherry, lime, lemon, apple, orange, and combinations of the foregoing. The candy products may further comprise one or more acids that impart a sour flavor, including but not limited to citric acid, ascorbic acid, tartaric acid, acetic acid, fumaric acid, lactic acid, and combinations of the foregoing. The natural and/or artificial flavor agents and the acid comprise less than about 2 wt. % or about less than 1 wt. % of the gelatin-based candy product.

In some embodiments, the candy products further comprise a small quantity of oil and/or wax such as vegetable oil, coconut oil, and/or carnauba wax. The oil and/or wax comprise less than about 0.5 wt. %, less than about 0.25 wt. %, or less than 0.2 wt. % of the gelatin-based candy product. Additionally, the candy products may further comprise one or more food colorings.

An example of a suitable formulation and resulting gelatin-based candy product is provided below:

### Example 1: Formula

TABLE 1
Ingredient concentrations in initial formulation and finished
gelatin-based candy product formed from the initial formulation.

| | Initial | Gelatin-based candy |
|---|---|---|
| Ingredient | Formulation (wt. %) | Product (wt. %) |
| Water | 24.90% | 19.00% |
| Invert Sugar | 34.72% | 37.45% |
| Sucrose | 34.69% | 37.41% |
| Gelita Gelatin (175 | 5.70% | 6.14% |
| Bloom) | | |

The gummy bears formed according to Table 1 show improved softness, pliability, and flavor release at cold temperatures compared to conventional gelatin-based candies.

The present disclosure may comprise one or more of the following features and combinations thereof.

According to the present disclosure, a cold dessert includes a cold sweetened food having a temperature from about −75° C. to about 3° C. and a gelatin-based candy including about 15 to about 70 wt. % invert sugar.

In illustrative embodiments, the gelatin-based candy includes gelatin. The gelatin-based candy includes about 4 to about 8 wt. % gelatin and less than about 0.1 wt. % of any gelling component other than the gelatin. The gelatin has a bloom number of about 150 to about 225.

In illustrative embodiments, the gelatin has a bloom number of about 150 to about 200.

In illustrative embodiments, the gelatin-based candy includes about 10 to about 20 wt. % water.

In illustrative embodiments, the gelatin-based candy includes about 30 to about 50 wt. % sucrose.

In illustrative embodiments, the gelatin-based candy includes less than about 1 wt. % high fructose corn syrup.

In illustrative embodiments, the cold sweetened food is a cold dairy-based dessert or a cold diary-substitute-based dessert. The cold sweetened food is a cold dairy-based dessert or a cold diary-substitute-based dessert. The cold sweetened food is ice cream, soft-serve ice cream, gelato, frozen custard, soy milk ice cream, nut milk ice cream, coconut milk ice cream, avocado-based ice cream, frozen yogurt, frozen Greek yogurt, frozen kefir, a parfait, sorbet, sherbet, frozen novelty, frozen stick confection, water ice confection, cheesecake, cake, pie, a milkshake, a malt, a smoothie, frozen fruit, Italian ice, a snow cone, whipped cream, or a combination of the foregoing. The gelatin-based candy is mixed into the cold sweetened food.

In illustrative embodiments, the cold sweetened food comprises a coating comprising the gelatin-based candy. In some embodiments, the coating of gelatin-based candy comprises a partial coating of the cold sweetened food. In some embodiments, the coating of gelatin-based comprises a shell surrounding the cold sweetened food. For example, the shell can be a hardened shell comprising the gelatin-based candy. In some specific examples, the cold sweetened food is a frozen novelty wherein the gelatin-based candy partially or fully surrounds the frozen novelty. In other specific examples, the cold sweetened food is a frozen stick confection wherein the gelatin-based candy partially or fully surrounds the frozen stick confection. In other specific examples, the cold sweetened food is a water ice confection wherein the gelatin-based candy partially or fully surrounds the water ice confection.

In illustrative embodiments, the cold sweetened food comprises a variegate comprising the gelatin-based candy. For example, the gelatin-based candy can comprise one or more food colorings to provide the variegate.

In illustrative embodiments, the cold sweetened food comprises the gelatin-based candy in an interior of the cold sweetened food. For example, the gelatin-based candy can comprise a “core” on the interior of the cold sweetened food. In some embodiments, the gelatin-based candy is provided inside the cold sweetened food so that the cold sweetened food surrounds the gelatin-based candy. In other embodiments, the gelatin-based candy is provided inside the cold sweetened food so that the cold sweetened food partially surrounds the gelatin-based candy. In yet other embodiments, the gelatin-based candy is provided inside the cold sweetened food so that the cold sweetened food comprises an inclusion, wherein the inclusion is the gelatin-based candy.

In illustrative embodiments, the cold sweetened food comprises the gelatin-based candy such that the entirety of the cold sweetened food comprises the gelatin-based candy. In these embodiments, the gelatin-based candy comprises both the outer shell of the cold sweetened food and the interior of the cold sweetened food. In some embodiments, the cold sweetened food comprises the gelatin-based candy such that the entirety of the cold sweetened food consists essentially of the gelatin-based candy. In some embodiments, the cold sweetened food comprises the gelatin-based candy such that the entirety of the cold sweetened food consists of the gelatin-based candy.

According to another aspect of the present disclosure, a gelatin-based candy may include about 15 to about 85 wt. % invert sugar, about 4 to about 8 wt. % gelatin, where the gelatin has a bloom number of about 150 to about 225, and about 5 to about 20 wt. % water. According to another aspect of the present disclosure, a gelatin-based candy may consist essentially of about 15 to about 85 wt. % invert sugar, about 4 to about 8 wt. % gelatin, where the gelatin has a bloom number of about 150 to about 225, and about 5 to about 20 wt. % water. According to another aspect of the present disclosure, a gelatin-based candy may consist of about 15 to about 85 wt. % invert sugar, about 4 to about 8 wt. % gelatin, where the gelatin has a bloom number of about 150 to about 225, and about 5 to about 20 wt. % water.

In illustrative embodiments, the gelatin-based candy includes about 30 to about 50 wt. % invert sugar. In illustrative embodiments, the gelatin-based candy consists essentially of about 30 to about 50 wt. % invert sugar. In illustrative embodiments, the gelatin-based candy consists of about 30 to about 50 wt. % invert sugar.

In illustrative embodiments, the gelatin-based candy includes 5 to about 7 wt. % of the gelatin. In illustrative embodiments, the gelatin-based candy consists essentially of 5 to about 7 wt. % of the gelatin. In illustrative embodiments, the gelatin-based candy consists of 5 to about 7 wt. % of the gelatin. The gelatin has a bloom number of about 150 to about 200.

In illustrative embodiments, the gelatin-based candy includes about 30 to about 50 wt. % of one or more additional sweeteners. In illustrative embodiments, the gelatin-based candy consists essentially of about 30 to about 50 wt. % of one or more additional sweeteners. In illustrative embodiments, the gelatin-based candy consists of about 30 to about 50 wt. % of one or more additional sweeteners.

In illustrative embodiments, the gelatin-based candy includes about 30 to about 50 wt. % sucrose. In illustrative embodiments, the gelatin-based candy consists essentially of about 30 to about 50 wt. % sucrose. In illustrative embodiments, the gelatin-based candy consists of about 30 to about 50 wt. % sucrose.

In illustrative embodiments, the gelatin-based candy has a temperature of about −75° C. to about 3° C.

In illustrative embodiments, the gelatin-based candy includes less than about 1 wt. % high fructose corn syrup.

In illustrative embodiments, the gelatin-based candy includes less than about 0.1 wt. % of any gelling component other than the gelatin.

According to another aspect of the present disclosure, a gelatin-based candy may include about 36 to about 39 wt. % invert sugar, about 36 to about 39 wt. % sucrose, about 5.5 to about 6.5 wt. % gelatin having a bloom number of about 175, and about 17 to about 20 wt. % water. The gelatin-based candy includes less than about 1 wt. % high fructose corn syrup. The gelatin-based candy includes less than about 0.1 wt. % of any gelling component other than gelatin.

According to another aspect of the present disclosure, a gelatin-based candy consists essentially of about 36 to about 39 wt. % invert sugar, about 36 to about 39 wt. % sucrose, about 5.5 to about 6.5 wt. % gelatin having a bloom number of about 175, and about 17 to about 20 wt. % water. The gelatin-based candy includes less than about 1 wt. % high fructose corn syrup. The gelatin-based candy includes less than about 0.1 wt. % of any gelling component other than gelatin.

According to another aspect of the present disclosure, a gelatin-based candy consists of about 36 to about 39 wt. % invert sugar, about 36 to about 39 wt. % sucrose, about 5.5 to about 6.5 wt. % gelatin having a bloom number of about 175, and about 17 to about 20 wt. % water. The gelatin-based candy includes less than about 1 wt. % high fructose corn syrup. The gelatin-based candy includes less than about 0.1 wt. % of any gelling component other than gelatin.

1. A gelatin-based candy comprising
about 25 to about 85 wt. % invert sugar,
about 4 to about 8 wt. % of a gelatin, wherein the gelatin has a bloom number of about 150 to about 225, and
about 5 to about 20 wt. % water.

2. The gelatin-based candy of claim 1, wherein the gelatin-based candy comprises about 30 to about 50 wt. % invert sugar.

3. The gelatin-based candy of claim 1, wherein the gelatin-based candy comprises about 5 to about 7 wt. % of the gelatin.

4. The gelatin-based candy of claim 1, wherein gelatin has a bloom number of about 150 to about 200.

5. The gelatin-based candy of claim 1, further comprising about 30 to about 50 wt. % of one or more additional sweeteners.

6. The gelatin-based candy of claim 1, further comprising about 30 to about 50 wt. % sucrose.

7. The gelatin-based candy of claim 1, wherein the gelatin-based candy has a temperature of about −75 to about 3° C.

8. The gelatin-based candy of claim 1, wherein the gelatin-based candy comprises less than about 1 wt. % high fructose corn syrup.

9. The gelatin-based candy of claim 1, wherein the gelatin-based candy comprises less than about 0.1 wt. % of any gelling component other than the gelatin.

10. A cold dessert comprising
a cold sweetened food having a temperature from about −75 to about 3° C. and
a gelatin-based candy comprising about 25 to about 70 wt. % invert sugar.

11. The cold dessert of claim 10, wherein the gelatin-based candy comprises gelatin.

12. The cold dessert of claim 11, wherein the gelatin-based candy comprises about 4 to about 8 wt. % of the gelatin and less than about 0.1 wt. % of any gelling component other than the gelatin, and the gelatin has a bloom number of about 150 to about 225.

13. The cold dessert of claim 11, wherein gelatin has a bloom number of about 150 to about 200.

14. The cold dessert of claim 10, wherein the gelatin-based candy comprises about 10 to about 20 wt. % water.

15. The cold dessert of claim 10, wherein the gelatin-based candy comprises about 30 to about 50 wt. % sucrose.

16. The cold dessert of claim 10, wherein the gelatin-based candy comprises less than about 1 wt. % high fructose corn syrup.

17. The cold dessert of claim 10, wherein the cold sweetened food is a cold dairy-based dessert or a cold diary-substitute-based dessert.

18. The cold dessert of claim 17, wherein the cold sweetened food is selected from the group consisting of ice cream, soft-serve ice cream, gelato, frozen custard, soy milk ice cream, nut milk ice cream, coconut milk ice cream, avocado-based ice cream, frozen yogurt, frozen Greek yogurt, kefir, a parfait, sorbet, sherbet, frozen novelty, frozen stick confection, water ice confection, cheesecake, cake, pie, a milkshake, a malt, a smoothie, frozen fruit, Italian ice, a snow cone, whipped cream, and combinations of the foregoing.

19. The cold dessert of claim 17, wherein the gelatin-based candy is mixed into the cold sweetened food.

20. A gelatin-based candy comprising
about 36 to about 39 wt. % invert sugar,
about 36 to about 39 wt. % sucrose,
about 5.5 to about 6.5 wt. % of a gelatin, wherein the gelatin has a bloom number of about 175, and
about 17 to about 20 wt. % water,
wherein the gelatin-based candy comprises less than about 1 wt. % high fructose corn syrup and less than about 0.1 wt. % of any gelling component other than the gelatin.
